(19) United States
(12) Patent Application Publication
(10) Pub. No.: US 2007/0180263 A1
(43) Pub. Date: Aug. 2, 2007

(54) Identification and remote network access using biometric recognition

(76) Inventors: David Delgrosso, Naperville, IL (US); Fraser Orr, Naperville, IL (US)

Correspondence Address: SCHWARTZ COOPER CHARTERED;IP DEPARTMENT, 180 NORTH LASALLE STREET, SUITE 2700, CHICAGO, IL, 60601, US

(21) Appl. No.: 11/639,386

(22) Filed: Dec. 14, 2006

Related U.S. Application Data
(60) Provisional application No. 60/751,058, filed on Dec. 16, 2005.

(51) Int. Cl. H04K 1/00

(52) U.S. Cl. 713/186

(57) ABSTRACT

Apparatuses and methods for setting-up, implementing and using a remote network access using a biometric recognition system is described. The system utilizes a user machine (10), host web server (20), secure server (100), authentication server (70) and controlling programs (72,25) to trigger or prompt and filter information.

### RELATED APPLICATIONS

The present application claims the benefit of U.S. Provisional Application No. 60/751,058, filed Dec. 16, 2005, the contents of which are incorporated herein by reference.

### TECHNICAL FIELD

The present invention relates to an authentication system interposed between a user at a remote location and a host website and server to prompt, receive and compare user information and a biometric tag (fingerprint or other biometric) so as to identify a user and/or control user access to and functionality of a secure server through, for example, the host server.

### BACKGROUND OF THE INVENTION

Web-based commerce offers consumers and businesses the ultimate in convenience. It also has the potential for bringing staggering losses to financial institutions and merchants. Banks, e-businesses and transaction processors must protect data from unauthorized intrusion and fraudulent transactions whether it comes from within the organization or from external hackers.

A standard, common layer of protection or security is to use PIN's or passwords prior to gaining access to a secured website for information and/or making transaction. When a computer recognizes a PIN or password, it is acknowledging the numbers and the letters keyed into the system, and not the person entering them, are trying to gain access into the secured system. Regrettably, through various means, PIN's and passwords on a desktop or laptop computer are very vulnerable to unauthorized outsiders. In addition, keystroke logging, adware programs, and trojan viruses can be used by hackers to steal the data needed to access a secured website. With only a few keystrokes, a hacker or thief can easily steal the data needed to conduct a fraudulent transfer, such as a wire transfer, credit card purchase, online banking withdrawal, or other electronic business activity. In short, many believe security is weakest at the remote or local, desktop/laptop level. Aggravating this situation, password overload leads to security lapses as passwords and PIN's are lost, forgotten, or compromised. These and other problems are addressed by the present remote network access using a biometric recognition system.

### SUMMARY OF INVENTION

The recognition system of the present development works with a host web browser at the server level without any record or storage of PIN's, passwords or biometric data being stored on the local machine. The system secures identities before data is transferred to and from a secured server or file such as an intranet, internet or other type of location (remote from the local user). The system captures the user's fingerprint on a lightweight fingerprint reader at the local machine and then encrypts and transmits the biometric data to be sent to the server for authentication. The authentication takes place at the host website (verses the local machine) preferably behind security and firewall technology. No record of PIN's, passwords, or biometric data resides on the local computer.

The present system is designed primarily for financial institutions, transaction service providers and merchants. However, the system can be used in other areas. The system minimizes, if not eliminates, security concerns and protects sensitive data by authenticating an authorized user's unique fingerprint, as opposed to a PIN or password.

The system is inserted into existing systems without much effort. Specifically, it is meant to easily integrate into existing web infrastructures. Some additional wiring may be necessary, but it is minimal.

The present remote network access using biometric recognition system captures the user's biometric information (e.g., fingerprint) on a portable, lightweight reader at the local machine, then translates and encrypts the biometric data to be sent to the server for authentication. The authentication database, compiled through a simple enrollment process, is maintained on the corporate or central server or off-site server.

Some benefits and advantages of the present remote network access using biometric recognition system include:

Offering a truly secure method of securing electronic transactions—biometric authorization takes place at the host website's secure environment—not at the local machine where password and PIN's can be entered by anyone;

Installing easily by end users—by installing a small internet Explorer plug-in (or other plug-in for Mozilla, Firefox, Opera, etc.) such and the software driver for the biometric reader, an end user is ready to go. (a biometric reader plugs into an available USB port on the end user's computer);

Fostering goodwill by providing customers and employees with the electronic security and peace of mind due to extra precautions or steps taken to ensure transactions by specific, authorized individuals; and,

Spending less time and less money chasing fraud—the system allows one to be proactive and prevent internet fraud before it happens by preventing transactions from taking place unless they are biometrically authenticated.

According to one aspect of the present invention, a method of adding biometric security to a communication for a transaction initiated from a remote computer and processed by a central server over a network connection (e.g., wired or wireless Internet connection) is provided. The method comprises sending a request for traditional security information for an entity from the central computer to the remote computer. The entity can be a person, or a company (represented by a person with authority to act on behalf of the company). The method further comprises receiving traditional security information for the entity at the central computer from the remote computer and a receiving at the central computer a request for a transaction for the specific entity from the remote computer. For certain transactions (e.g., financial transactions, such as clearing a debit request), additional security measures are implemented. In such instances, the method comprises sending from the central computer to the remote computer a request to enter a biometric for the specific entity. A biometric device (a biometric reader or receiver) connected to the remote computer, such as—for example—a fingerprint reader, can be utilized to generate the biometric for the specific entity. The biometric device can be connected to the remote computer via a line connection, or may be integrally part of the remote computer.

The method can then comprise receiving the biometric for the specific entity at the central computer from the remote computer and comparing the biometric for the specific entity received from the remote computer with biometric enrollment information stored in memory at the central computer. This biometric enrollment information can be previously obtained, verified and stored in memory without any direct interaction with the specific entity at that time. The method can then comprise executing the transaction at the central computer in response to the biometric for the specific entity received from the remote computer matching the biometric enrollment information stored in memory at the central computer.

The method can additionally comprise the step of appending a representation of at least a portion of the biometric enrollment information to the transaction for tracking the entity requesting the transaction. Similarly, the method can also comprise appending a representation of combined security information to the transaction for tracking the entity requesting the transaction, wherein at least a part of the combined security information comprises at least a portion of the biometric enrollment information.

The method can also comprise transmitting private financial information of a specific entity to the remote computer for viewing by the specific entity. This may include modifying a webpage communication to include entity specific financial information and, transmitting the modified webpage communication to the remote computer.

The method can be set up so that a biometric is requested only if a predetermined threshold for a transaction is satisfied. The predetermined threshold can be a dollar amount where the transaction is one of a debit request and a credit request. Alternatively, the predetermined threshold is a time passed since a last transaction or a time passed since a beginning of an entity session.

In accordance with another aspect of the present invention, a method of enrolling an individual into a biometric security system for using biometric security in a communication for a transaction initiated from a remote computer and processed by a central server is provided. The method comprises receiving at the central computer a request to enroll a specific entity in the biometric security system from the remote computer, and sending from the central computer to the remote computer a request to enter a biometric for the specific entity, and a request to enter a plurality of security answers to a plurality of security questions. The method further comprises receiving at the central computer a plurality of answers to the plurality of questions and the biometric for the specific entity, from the remote computer and receiving at the central computer trustworthy information associated with the specific entity from a remote trusted source. Upon receipt of this information, the method includes comparing the plurality of security answers to the trustworthy information and, enrolling the specific entity requesting enrollment into the biometric security system if the comparison of the plurality of security answers to the trustworthy information determines that the specific entity requesting enrollment is the same entity as the specific entity associated with the trustworthy information.

The step of enrolling can comprise storing a representation of the biometric in the central computer, and associating the biometric with stored security information for the specific entity. The stored security information can comprise biographical information, a username and a password for the specific entity.

The central computer utilized in the method can comprise a first server and a second server. The first server is utilized for sending and receiving communications with the remote computer and the second server. In this regard, the first server handles all biometric security system functionality. The second server can be utilized to perform traditional financial entity functionality.

Trustworthy information (as utilized in the methods and systems disclosed) may comprise at least one or more of credit information, credit history information, family history information, biological information, and other personal information for the entity. Other information can also be considered trustworthy information depending on the transaction or other factors at issue.

The step of comparing the plurality of security answers to the trustworthy information can comprise applying a risk analysis algorithm to the results of the comparison. The risk analysis algorithm can be configured for providing a risk analysis outcome indicative of the probability that the specific entity is actual an entity from which the trustworthy information is associated with.

The one or more of the plurality of security questions can be customized for the specific entity. Additionally, the central computer can be configured to insert information about the specific entity's family history and/or biographical information and/or credit history into at least one or more of the security questions.

In the methods of the present invention, the central computer can be a server and the remote computer a client. Communications can take place over the internet. Moreover, the biometric can be received through a biometric receiver attached to the remote computer.

The step of storing a representation of the biometric in the central computer can comprise encrypting the biometric with an encryption key. The method can then further comprise storing the encryption key with an escrow agent. In such instances, the method can also include the step of releasing the encryption key from the escrow agent only in response to a fraud investigation involving a transaction related to the specific entity, to decrypt the encrypted biometric which had been appended to the transaction to determine if the specific entity or some other entity actually requested the transaction.

In accordance with another embodiment of the invention, the method of adding biometric security to a communication for a transaction initiated from a remote computer and processed by a central server provided. The method comprises the steps of: sending a request for traditional security information for an entity from the central computer to the remote computer; receiving traditional security information for the entity at the central computer from the remote computer; receiving at the central computer a request for a transaction for the specific entity from the remote computer; sending from the central computer to the remote computer a request to enter a biometric for the specific entity; receiving the biometric for the specific entity from the remote computer; comparing the biometric for the specific entity received from the remote computer with biometric enrollment information stored in a memory, wherein the biometric enrollment information had been previously obtained; and, executing the transaction in response to the biometric for the specific entity received from the remote computer matching the biometric enrollment information stored in the memory.

The method can further comprise sending the biometric of the specific entity to an authentication server by the central computer, wherein the authentication server compares the biometric for the specific entity with the biometric enrollment information and, receiving the results of the comparison from the authentication server. The method can further include providing a plug-in component between the central computer and the authentication server for facilitating communication between the central computer and the authentication server.

The method can further comprise the authentication server communicating with the memory for comparing the specific entity biometric with the biometric enrollment information stored in the memory. The memory can be a database of the enrolled information.

The executing step can include the transaction step include sending the transaction to a secure server by the central computer. The secure server can complete the transaction.

The method can also include encrypting the biometric of the specific entity by the remote computer. The comparing step can then include comparing the encrypted biometric of the specific entity with the biometric enrollment information wherein the biometric enrollment information is maintained in an encrypted format. Thus, the comparing is done without decoding the encrypted biometric of the specific entity.

In accordance with another embodiment of the invention, a method of securely allowing a remote user to initiate a transaction on a secure server is provided. The method comprises the steps of: receiving a request for a transaction from a remote system by a server hosting a web site; receiving a biometric tag of a user of the remote system by the hosting server; transmitting the biometric tag to an authentication server by the hosting server; comparing the biometric tag of the user with biometric information in a database of enrolled users; and, allowing the transaction to be completed by the secure server if the comparison indicates the user is an enrolled user. The method can further comprise sending a message to the remote system indicating a denial of the transaction if the comparison indicates the user is not an enrolled user. Moreover, the method can include maintaining a proxy web site for receiving the transaction request and the biometric tag, the proxy web site communicating with the hosting server.

Additionally, in accord with another aspect of the invention, the system can be utilized to simply identify a person and/or provide relevant information or status data regarding the person. For example, a business, such as a fitness center or gym might use the system in connection with a web site that has members enrolled at a central location. To implement the system in this example, the fitness center's front desk may have an employee logged onto the web site. A member of the fitness center could then walk up to the front desk and place their finger on a fingerprint scanner (or utilize some other biometric device). The system could then identify the member and indicate the member's status or provide other information regarding the member (e.g., membership record). This would eliminate the need for the member to carry and provide a membership pass or identification. This also allows the fitness center to easily monitor and keep track of the people currently utilizing the facility.

According to yet another aspect of the invention, the system can be configured to host a web site by proxy, and utilize the present invention on the proxy rather than the original web site. This allows a user of the invention to utilize the system without changing the original web site. In many instances, changing a web site is a large and complex process that may involve significant cost and effort, both in development work and in obtaining and managing the necessary authorizations. Moreover, web site managers are often reluctant to make changes to existing infrastructures with unknown software until it has been proved reliable. By using a proxy system a use can utilize the system without effecting or otherwise impacting the original site.

The invention also includes a computer program product having segments of code for implementing each of the method steps or functionality described herein. The computer program product can be stored, for example, on the hard drive of one or more computers involved in the system or method, or on other computer readable media or components such as a CD or DVD.

Other advantages and aspects of the present invention will become apparent upon reading the following description of the drawings and the detailed description of the invention.

### BRIEF DESCRIPTION OF THE DRAWINGS

In the accompanying drawings forming part of the specification, and in which like numerals are employed to designate like parts throughout the same,

FIG. 1 is a schematic diagram of a typical system wherein the local machine is connected to a web server or host;

FIG. 2 is the schematic diagram of FIG. 1 wherein the present remote network access using biometric recognition system is introduced therein; and,

FIG. 3 is a schematic diagram illustrating use of a proxy web site in connection with the present invention.

### DETAILED DESCRIPTION OF THE INVENTION

While this invention is susceptible of embodiments in many different forms, there is shown in the drawings and will herein be described in detail, preferred embodiments of the invention with the understanding the present disclosure is to be considered as an exemplification of the principles of the invention and is not intended to limit the broad aspect of the invention to the embodiments illustrated. The present invention will have the following main components and techniques for operation of the device.

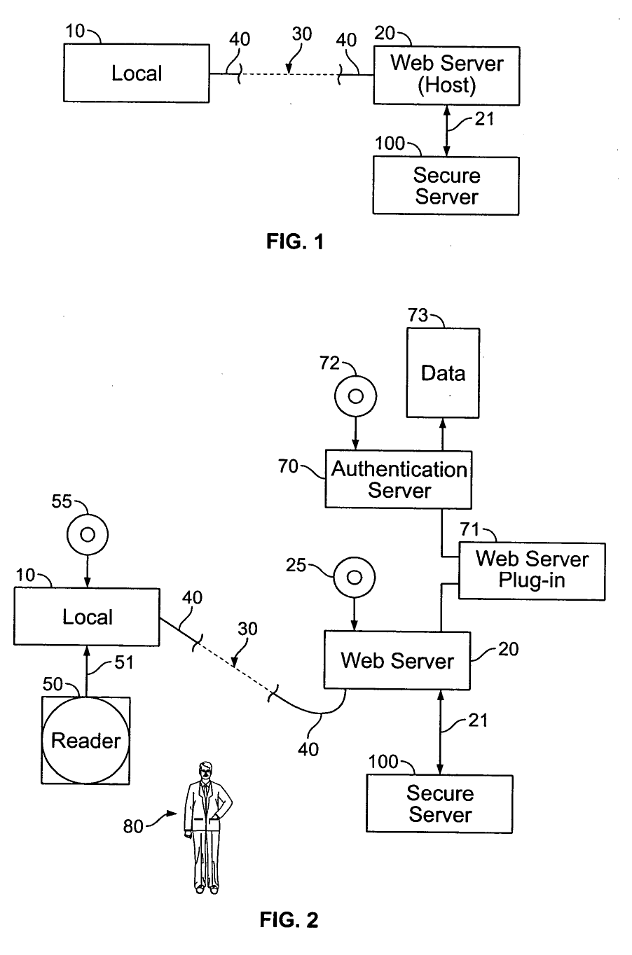

FIG. 1 shows a typical known system. A local machine (e.g., a computer or some other similar device dedicated for a particular use, such as an ATM) acts as a remote system 10 (or user system) having one or more individuals working at a remote location. A host or web server 20 (e.g., a central computer) is a server hosting a typical web site or acting as a web services provider for the web site.

The link between the remote/local system and the web server is the internet 30 and hard wires (Dial-Up, DSL, T-1, WiFi) and/or cables (cable connection) 40. However, a wireless connection can also be utilized. A secure server 100 is connected 21 to the host server 20 for making secure transactions, such as a wire transfer, credit card purchase, online banking withdrawal, or other electronic business activity or accessing secure information, such as account information or subscriber information, etc.

Typically, an individual on the remote system 10 (which includes an associated keyboard and mouse) making a transaction or trying to gain access to secure information with the web server 20 physically inputs (automatically generated by the remote system or manually entered through the keyboard) his/her username and password or personal identification number (PIN) to access the secure information or make or complete the secured transaction. The transaction or secure information is conducted or stored on the secure server 100. In most situations, the host server 20 has software therein that authenticates the user and his or her password or PIN. Thus, when the correct username and password or PIN are entered on the remote machine 10 and transferred to the host server 20, access to the secure server 100 is permitted. The usernames, passwords and PIN's are stored on the host server 20 where the comparison operation occurs and often on the remote system 10 for call-back when necessary. Accordingly, if the host server 20 or remote system 10 is compromised, user and password or PIN information may also be compromised.

FIG. 2 shows the system with the present invention (incorporating the QRL fingerprinting identification system) incorporated and inserted therein. A biometric reader 50 is connected via a USB connection 51 to the terminal 10 and a small internet Explorer plug-in 55 is installed at the user's system/terminal. It is, of course, recognized that other plug-ins can be used, such as those associated with Mozilla, Firefox, Opera, etc. The reader 50 and terminal of the remote system 10 with additional software 55 permit the user to have a biometric attribute read by the reader encrypted and transmitted. Thus, each time as requested or prompted for biometric information, a user can put his or her finger in contact with the fingerprint reader 50, which, in turn, scans and reads the fingerprint, encrypts it and transmits the encrypted information to the source that requested or prompted a request for the biometric information. The encrypted information generated and transmitted by the user's system 10 is called the “biometric tag.” This biometric tag can be a data stream, an equation, an encoded model, or other digital mechanism of the biometric feature or attribute being scanned. Each biometric attribute/feature read by the scanner results in a unique biometric tag. In short, the biometric tag generated is unique for each individual and for each biometric attribute (finger, eye, palm, handwriting, etc.) being read. Put another way, a biometric tag becomes a password unique to an individual and dictated by something specific associated with an individual, such as a biometric attribute, dictated by things generally outside the control of an individual (a person's unique fingerprint).

In one embodiment, at the host end of the transaction or communication, the web server 20 is not only connected 21 to the secure server 100, but also to a separate authentication server 70. This authentication server 70 is ideally physically separated from the host server 20 and behind a firewall (not shown) within the IT department's infrastructure security. For the sake of clarity and explanation, the authentication server 70 and the host server 20 are presented, discussed and shown as two separate servers. Although not ideal, in another embodiment it should be recognized that they 20,70 can be the same server and need not be separate. The authentication server 70 has a program 72 thereon and data 73 therein permitting it to receive the encrypted information or biometric tag transmitted to it by the host server 20, compare the encrypted information or biometric tag with the data 73 stored thereon and make a determination of whether there is a proper match or not. Specifically, a separate database 73 associated with the authentication server 70 includes a listing of usernames or other key user identifiers, such as email address, and each's unique biometric tag, such as the encrypted reading of a user's thumbprint (again, the database 73 can be physically separate from the authentication server 70, or stored separately in a memory of the authentication server). Thus, the two pieces of data—the user identifier (username, email address, etc.) and the biometric tag (fingerprint, eye scan, etc.)—are transmitted to the server 20 by a user entity (e.g., a person or user) of the remote system 10 and passed to the authentication server 70 where they are compared in the authentication server 70.

If the comparison made by the authentication server 70 fails to yield a proper match between the information transmitted and the information in the database 73, the user will be blocked from making any further transactions, such as gaining access to the secured website hosted by the secure server 100 or conducting further e-business activities, such as a purchase or transfer of funds. The authentication server 70 transmits this denial to the host server 20, which, in turn, transmits a message to the user of the remote system 10 in a message. On the other hand, if the comparison made by the authentication server 70 results in a proper match between the information transmitted and the information in the database 73, the user will be permitted and allowed to gain access to the secure server 100 and conduct further e-business activities, such as a purchase or transfer of funds or review secure information. The authentication server 70 transmits this granting or the “no denial” to the host server 20, which, in turn, permits access by the user of the remote system 10 to the secure server 100. Specifically, if the comparison yields a proper match, the user requesting access to the secured website supported by the secure server 100 is given access thereto by the host server 20 and the transaction or e-business activity continues on the secured website.

Preferably, no images or exact electronic information of actual biometric tags (such as a finger print image) or encrypted information are stored in or on the host server 20. Further, no biometric tags or encrypted information are stored in or on the remote system 10, namely the user's machine. Accordingly, hackers or individuals gaining access to host server 20 or to the user's remote system 10 gain nothing or hack nothing for nothing can be stolen.

The authentication server 70 acts as a filter between the user's system 10 and the host server 20. However, it should be noted that the authentication server 70 only makes a comparison between the data it receives (username and biometric tag) and the data it has stored through an enrollment process (listing of usernames and associated biometric tags). The server 70 does not decode, decrypt or convert the biometric tags in anyway. The software 72 provided to the authentication server 70 does not have such a function; it simply reads and tries to match the biometric tags (e.g., a data stream, an equation, an encoded model, or other digital mechanism of the biometric feature or attribute being scanned) forwarded to it. As a result, one cannot take the biometric tag and do anything with it or use it for any other purpose. Specifically, the system as described thus far cannot take the biometric tag transmitted and/or received and convert it back to a specific code, e.g., a picture, for the fingerprint scanned. Thus, even if the authentication server 70 was compromised, it would do no good because the data (e.g., the biometric tags in the form of a data stream, an equation, an encoded model, or other digital mechanism of the biometric feature or attribute being scanned) would have no meaning outside the server 70.

The algorithm for encoding, encrypting and converting of the biometric feature or attribute, such as a fingerprint, by the reader 50 is unique to the reader 50 and user software 55 and works only in transactions involving the authentication server 70 and its software 72. The algorithm(s) for encoding, encrypting and converting the biometric tags and decoding, decrypting and converting back the biometric tags is held by a separate, outside third party key-holder 80. Conceptually, the third party key holder 80 acts as an escrow agent, who, under circumstances, has the ability to decrypt, decode and convert the biometric tags. Thus, if necessary, such as by court order, the third party 80 can take the biometric tags transmitted by users or stored in the database 73 and decode, decrypt or convert them to read or interpret the biometric feature being read by the reader. For example, given a particular biometric tag, the third party key-holder 80 can reconstruct, or partially reconstruct, a picture of a user's and/or transmitter's fingerprint. If desired, the third party holder 80 can also have a copy of the authentication server 70 and/or database 73 so that it has a duplicative biometric tag data and perhaps transaction data. This separate copy can be held by the third party and recalled and decrypted if necessary, such as by a court order or pursuant to a criminal investigation.

A program 25 is installed in the host computer 20 to work with the software 72 associated with the authentication server 70 to permit the authentication server 70 to act as a filter, gatekeeper and trigger. A web server plug-in 71 is interposed between the servers 20,70. The web server 20 communicates with the web server plug-in 71. The plug-in 71 communicates with the authentication server 70. This allows the addition of a QRL system to the existing web site without making any changes (i.e., except for the addition of the plug-in 71). The plug-in 71 allows the web server 20 and the authentication server 70 to communicate with one another. In this manner, the authentication software 72 can control the access to the secure server 100.

The authentication system 70,72 becomes a middle-man between the host user at the remote system 10 and the host server 20 controlling the user's access to the secure server 100. In theory, the authentication system 70,72 acts in the place of a standard username and password/PIN. The biometric tag becomes the password. Apart from these changes described, the host server 20 and secure server 100 act as they did without the authentication system 70,72.

It should be noted that during this interaction with the authentication system, the authentication software is configured to be looking for signs of potential fraud, such as the use of an exactly matching fingerprint, or a stale fingerprint (based on a date corresponding to the collection of a fingerprint stored in the authentication database 73). Since each instance of a fingerprint read is a little different, an exact match probably indicates that a fingerprint (e.g., in an electronic format) from a previous scan is probably being fraudulently reused.

Certain “rules” can be turned on or off within the authentication programs (72,25) to dictate when the authentication system 70,72 prompts the user for a biometric tag. Thus, the authentication system 70,72 will insert itself and request a prompt for a biometric tag as the rules dictate. These rules can be modified, added, or removed by those running the authentication system.

The authentication system 70,72 is configured by a configuration file telling it where and when it should be involved resulting in a prompt for a biometric tag from a user. Alternatively, the host server and software 20,25 can be extensively customized to reduce the load on the authentication software 72.

In particular, the authentication system 70,72 prompts the user for biometric authentication information (e.g., a biometric tag) at certain times or at certain points during use of the system. For example, a prompt for a biometric tag may be generated every time a user makes a request to access the secure server 100, such as to make a purchase, transfer funds, pay bills, etc. In addition, a prompt can be set to occur at a time of enrollment when the initial information is gathered about a user and the biometric tag is required. Further triggers may include certain transactions, such as those above a certain amount or affecting a certain account or when a fraud alert is in effect.

It should be noted that certain criteria will need to be set-up and met before enrollment is possible in order to prevent fraudulent enrollments. Such information can be obtained in person or through other reliable sources, such as financial institutions or financial reporting agencies. Indeed, one important aspect of the present development is the ability for a user to enroll online without requiring any outside intervention. Such enrollment is accomplished by quizzing the on-line user for information about credit history, biographical information or other personal data, obtained from a trusted third party source (such as a credit agency, financial institution, personnel file, etc.). By using this data to quiz the user desiring enrollment, the system can automatically determine whether the user is, in fact, the actual person or an imposter, and thus confidently associate the biometric tag (e.g., fingerprint) with the associated account or transaction.

The authentication system 70,72 may also be set to trigger a prompt for a user's biometric tag “in the event” to ensure further that the specific user is, in fact, conducting the transaction or e-business activity. For example, if a user properly gained accesses to the secured website for a financial institution and is conducting business thereon and desires to transfer a large amount of money to another account, institution, or entity, the system 70,72 may prompt an immediate request for the user's biometric tag before conducting the transfer. This “in the event” request is made and the subsequent capture of the biometric tag ensures the individual initially gaining access to the secured server 100 is, in fact, the same individual desiring to make the transfer. This not only prevents misappropriations if someone leaves a computer open (e.g., the user goes to lunch while the user's browser is still connected to the secured website maintained or supported by the secure server 100), but also makes a permanent record to prevent the user from claiming at a later date that the requested and executed transfer was fraudulently made.

The authentication system 70,72 may also be set to trigger a prompt for a user's biometric tag when the user is transmitting from a particular IP address. The reasons are many. For example, certain IP addresses may be known for fraudulent activities. Or, certain addresses may be used for beta testing. One demonstrating the system, testing the system, or trying new or improved attributes of the system, may be transmitting from IP addresses where it is advantageous that the system know this and act accordingly and responsibly.

The general, overall procedure being followed is as follows:
1) A user at a remote system 10 requests access to a secure server 100 at the host website 20.
2) The authentication system 70,72 interacting with the website's server 20 prompts the user at the remote system 10 for biometric authentication.
3) The user uses a device 50 at the user's location (i.e., integral with or connected to the remote system 10) to read a biometric feature; the device 50 reads the biometric feature associated with the user and encrypts it; and, the remote system 10 transmits the encrypted information to the host website's server 20.
4) The host server 20 receives the encrypted information from the user of the remote system 10 and transmits it to a separate authentication server 70 behind a firewall that has a database 73 listing of all users and their corresponding encrypted biometric information. A comparison is made by the software 72 installed in the authentication server 70 between the requesting user and encrypted biometric information and all of the (already enrolled) users and their corresponding encrypted biometric information. The results of the comparison are transmitted from the separate authentication server 70 to the host server 20.
5) If the comparison fails to yields a proper match, the user requesting access to the secure server 100 is denied access thereto by the host server 20 and a message setting this forth is transmitted to the remote system 10 by the host server 20.
6) If the comparison yields a proper match, the user requesting access to the secure server 100 is permitted by the host server 20 and the transaction or e-business activity continues on the secure server 100.

In one embodiment, the biometric tag is a mathematical representation of the actual biometric feature, not just digital data of the actual biometric feature, and it is the mathematical representation that is used to identify an individual for the various purposes stated herein, and not the actual image of the biometric feature or an encrypted data or file of the actual image of the biometric feature (such as a finger print).

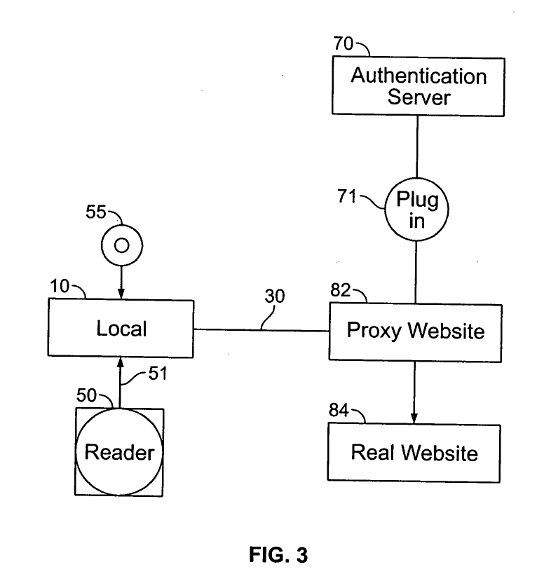

In accordance with a further embodiment of the invention, a proxy server maintaining a proxy web site 82 can be used with the authentication server 70 to implement the system. Referring to FIG. 3, a remote server 10 connects to the proxy server or web site 82 via a link 30 (e.g., the Internet). The proxy web site 80 acts as a host for a real web site 84. The proxy web site 82 communicates via a plug-in 71 to an authentication server 70 in the manner discussed above in order to authenticate a user (or simply to provide identification of one using the biometric device 50) of the remote system 10. No changes need to be made to the real web site 82 in this configuration. Accordingly, the system can be tried out without undertaking major efforts to revise the real web site 84.

The proxy web site 82 looks like a regular QRL set-up except that it does not obtain its pages locally. Rather, the proxy web site 82 copies them from the original (i.e., real) web site 84.

As discussed above, the system can be used simply to identify and/or provide status information of an entity. In this manner, a person can be allowed to enter a secure facility (e.g., a gym or fitness center, or other club or enterprise requiring membership and/or enrollment), by providing a biometric tag that is sent through a web server to an authentication server. The web server can provide membership information or status and also keep track of the person's use of the facility. This is particularly useful for facilities having multiple locations. For example, one traveling for business can use the local branch of a fitness center (of which he or she is a member) without requiring carrying a membership card.

While the specific embodiments have been illustrated and described, numerous modifications come to mind without significantly departing from the spirit of the invention and the scope of protection is only limited by the scope of the accompanying Claims.

We claim:

1. A method of adding biometric security to a communication for a transaction initiated from a remote computer and processed by a central server, comprising the steps of:
sending a request for traditional security information for an entity from the central computer to the remote computer;
receiving traditional security information for the entity at the central computer from the remote computer;
receiving at the central computer a request for a transaction for the specific entity from the remote computer;
sending from the central computer to the remote computer a request to enter a biometric for the specific entity;
receiving the biometric for the specific entity from the remote computer;
comparing the biometric for the specific entity received from the remote computer with biometric enrollment information stored in a memory, wherein the biometric enrollment information had been previously obtained; and,
executing the transaction in response to the biometric for the specific entity received from the remote computer matching the biometric enrollment information stored in the memory.

2. The method of claim 1 wherein the comparing step includes the steps of:
sending the biometric of the specific entity to an authentication server by the central computer, wherein the authentication server compares the biometric for the specific entity with the biometric enrollment information; and,
receiving the results of the comparison from the authentication server.

3. The method of claim 2 further comprising the authentication server communicating with the memory for comparing the specific entity biometric with the biometric enrollment information stored in the memory.

4. The method of claim 1 wherein the executing the transaction step includes:
sending the transaction to a secure server by the central computer.

5. The method of claim 2 further comprising:
providing a plug-in component between the central computer and the authentication server for facilitating communication between the central computer and the authentication server.

6. The method of claim 1 further comprising the step of:
encrypting the biometric of the specific entity by the remote computer.

7. The method of claim 6 wherein the comparing step includes:
comparing the encrypted biometric of the specific entity with the biometric enrollment information wherein the biometric enrollment information is maintained in an encrypted format, without decoding the encrypted biometric of the specific entity.

8. The method of claim 1 further comprising:
appending a representation of at least a portion of the biometric enrollment information to the transaction for tracking the entity requesting the transaction.

9. The method of claim 1 further comprising the steps of:
appending a representation of combined security information to the transaction for tracking the entity requesting the transaction, wherein at least a part of the combination comprising at least a portion of the biometric enrollment information.

10. A method of enrolling an individual into a biometric security system for using biometric security in a communication for a transaction initiated from a remote computer and processed by a central server, comprising the steps of:
receiving at the central server a request to enroll a specific entity in the biometric security system from the remote computer;
sending from the central server to the remote computer a request to enter a biometric for the specific entity, and a request to enter a plurality of security answers to a plurality of security questions;
receiving at the central server a plurality of answers to the plurality of questions and the biometric for the specific entity, from the remote computer;
receiving at the central server trustworthy information associated with the specific entity from a remote trusted source;
comparing the plurality of security answers to the trustworthy information; and,
enrolling the specific entity requesting enrollment into the biometric security system if the comparison of the plurality of security answers to the trustworthy information determines that the specific entity requesting enrollment is the same entity as the specific entity associated with the trustworthy information.

11. The method claim 10, wherein the step of enrolling comprises storing a representation of the biometric in the central server, and associating the biometric with stored security information for the specific entity.

12. The method claim 10, wherein the stored security information comprises biographical information, a username and a password for the specific entity.

13. The method claim 10, wherein the trustworthy information comprises at least one or more of credit information, credit history information, family history information, biological information, and other personal information for the entity.

14. The method claim 10, wherein the step of comparing the plurality of security answers to the trustworthy information comprises applying a risk analysis algorithm to the results of the comparison, for providing a risk analysis outcome indicative of the probability that the specific entity is actual an entity from which the trustworthy information is associated with.

15. The method of claim 11 wherein the step of storing a representation of the biometric in the central server comprises encrypting the biometric with an encryption key.

16. The method of claim 15 further comprising storing the encryption key with an escrow agent.

17. The method of claim 16 further comprising the step of releasing the encryption key from the escrow agent only in response to a fraud investigation involving a transaction related to the specific entity, to decrypt the encrypted biometric which had been appended to the transaction to determine if the specific entity or some other entity actually requested the transaction.

18. A method of securely allowing a remote user to initiate a transaction on a secure server comprising the steps of:
receiving a request for a transaction from a remote system by a server hosting a web site;
receiving a biometric tag of a user of the remote system by the hosting server;
transmitting the biometric tag to an authentication server by the hosting server;
comparing the biometric tag of the user with biometric information in a database of enrolled users; and,
allowing the transaction to be completed by the secure server if the comparison indicates the user is an enrolled user.

19. The method of claim 18 further comprising the step of:
sending a message to the remote system indicating a denial of the transaction if the comparison indicates the user is not an enrolled user.

20. The method of claim 18 further comprising the step of:
maintaining a proxy web site for receiving the transaction request and the biometric tag, the proxy web site communicating with the hosting server.
